(19) United States
(12) Patent Application Publication
(10) Pub. No.: US 2024/0280927 A1
(43) Pub. Date: Aug. 22, 2024

(54) IMAGE FORMING APPARATUS AND PRINT MEDIUM

(71) Applicants: Shintaro YAMADA, Osaka (JP); Hiroaki KATOH, Kanagawa (JP); Akihiro KAWASAKI, Kanagawa (JP)

(72) Inventors: Shintaro YAMADA, Osaka (JP); Hiroaki KATOH, Kanagawa (JP); Akihiro KAWASAKI, Kanagawa (JP)

(73) Assignee: Ricoh Company, Ltd., Tokyo (JP)

(21) Appl. No.: 18/422,555

(22) Filed: Jan. 25, 2024

(30) Foreign Application Priority Data
Feb. 21, 2023 (JP) 2023-024904

(51) Int. Cl. G03G 15/10; G03G 5/02; G03G 21/00

(52) U.S. Cl. CPC G03G 15/10; G03G 21/0088; G03G 5/0202; G03G 2215/0658

(57) ABSTRACT

An image forming apparatus includes a conductive medium, an applying device, and a developing device. The applying device applies conductive liquid to a surface of the conductive medium to form an invisible image. The developing device adheres charged particles to the invisible image formed on the surface of the conductive medium to form a visible image.

### CROSS-REFERENCE TO RELATED APPLICATION

This patent application is based on and claims priority pursuant to 35 U.S.C. § 119(a) to Japanese Patent Application No. 2023-024904, filed on Feb. 21, 2023, in the Japan Patent Office, the entire disclosure of which is hereby incorporated by reference herein.

### BACKGROUND

### Technical Field

Embodiments of the present disclosure relate to an image forming apparatus that forms a visible image on a surface of a conductive medium, and a print medium on which the visible image is formed on a printing surface.

### Related Art

Image forming apparatuses are widely known that charge a surface of a photoconductor drum having a photosensitive layer by a charging device, irradiate light by an exposure device to form an electrostatic latent image, and adhere dry toner or ink to the electrostatic latent image by a developing device to form a visualized toner image or ink image.

### SUMMARY

In an embodiment of the present disclosure, there is provided an image forming apparatus that includes a conductive medium, an applying device, and a developing device. The applying device applies conductive liquid to a surface of the conductive medium to form an invisible image. The developing device adheres charged particles to the invisible image formed on the surface of the conductive medium to form a visible image.

In another embodiment of the present disclosure, there is provided a print medium that includes a conductive layer and an insulating layer. The insulating layer is laminated on a printing surface side relative to the conductive layer and is absorptive of conductive liquid.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an image forming apparatus according to an embodiment of the present disclosure;

FIG. 2 is a schematic view of an image forming device of the image forming apparatus in FIG. 1, according to an embodiment of the present disclosure;

FIG. 3 is an enlarged view of an image area (invisible image) on a conductive drum formed of only a conductive layer to which charged particles adhere;

FIG. 4A is an enlarged view of an image area (invisible image) on a conductive drum to which charged particles adhere;

FIG. 4B is an enlarged view of a non-image area on the conductive drum of FIG. 4A to which charged particles do not adhere;

FIG. 5 is a schematic view of an image forming apparatus according to a first modification of an embodiment of the present disclosure;

FIG. 6 is a schematic view of an image forming apparatus according to a second modification of an embodiment of the present disclosure;

FIG. 7 is a schematic view of an image forming apparatus according to a third modification of an embodiment of the present disclosure; and

FIG. 8 is a cross-sectional view of a print medium used in the image forming apparatus in FIG. 7, according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. In the drawings, like reference signs denote like elements, and overlapping description may be simplified or omitted as appropriate. As used herein, the singular forms “a,” “an,” and “the” are intended to include the plural forms as well, unless the context clearly indicates otherwise.

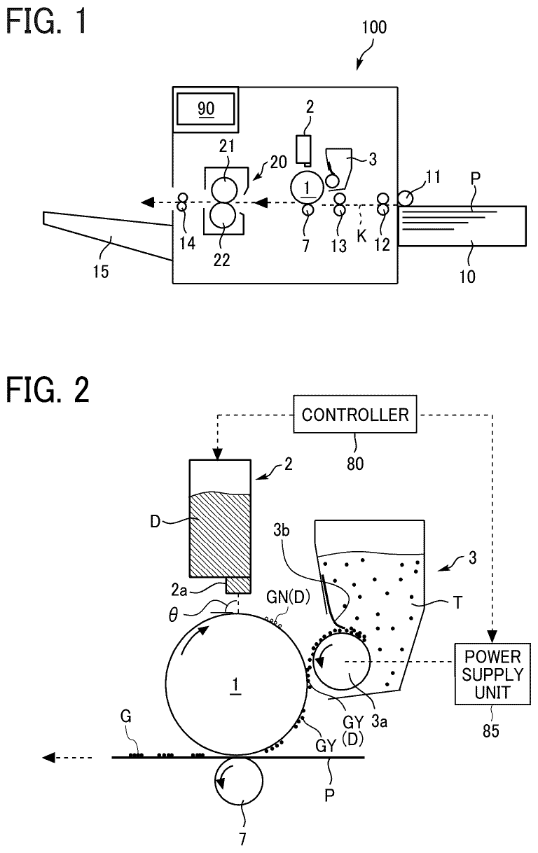

Initially with reference to FIGS. 1 and 2, a description is given of the overall configuration and operation of an image forming apparatus 100 according to an embodiment of the present disclosure. FIG. 1 is a schematic view of a configuration of the image forming apparatus 100 illustrated as a printer, according to an embodiment of this disclosure. FIG. 2 is an enlarged view of an image forming device of the image forming apparatus 100 of FIG. 1. As illustrated in FIG. 1, the image forming apparatus 100 according to the present embodiment does not include a charging device and an exposure device, unlike an electrophotographic image forming apparatus that includes a charging device and an exposure device. An operation display panel 90 is disposed in an exterior portion of the image forming apparatus 100 to display information from the image forming apparatus 100 and to input information on operation of the image forming apparatus 100.

With reference to FIGS. 1 and 2, the image forming device typically includes a conductive drum 1 serving as a conductive medium, and an applying device 2, a developing device 3, and a transfer device 7 disposed around the conductive drum 1. Image forming processes (an application process, a development process, and a transfer process) are performed on the conductive drum 1, and thus an image (a visible image GY) is formed on the conductive drum 1. The visible image GY formed on the conductive drum 1 is transferred, at a position (a transfer position) of the transfer device 7, to a sheet P (e.g., a widely-used sheet of paper) as a transferred object conveyed to the transfer position.

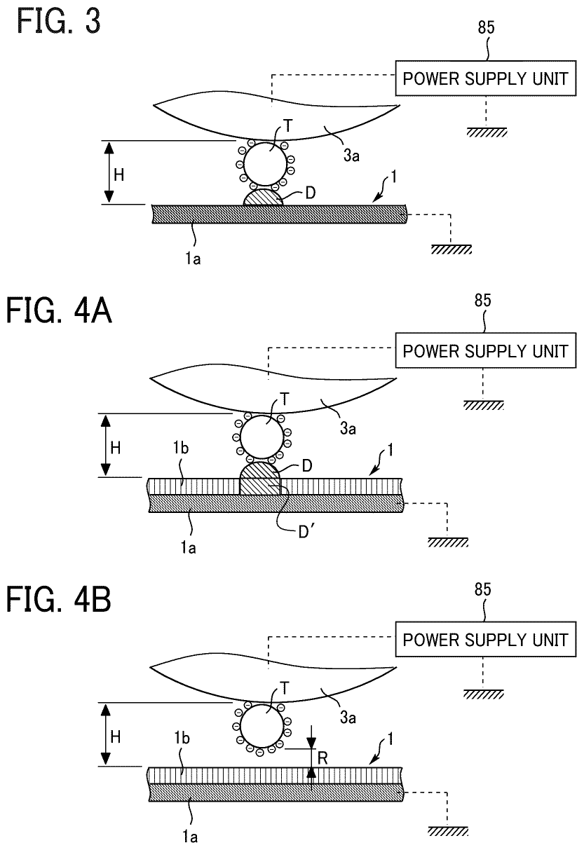

With reference to FIG. 2, the conductive drum 1 serving as a conductive medium is rotated clockwise by a main motor. At the position of the applying device 2, conductive liquid D is applied to the surface of the conductive drum 1 to form a desired invisible image GN (an application process). When the surface of the conductive drum 1 reaches a position opposite the developing device 3 (a developing roller 3a), charged particles T are adhered to the invisible image GN at the position opposite the developing device 3 to form the visible image GY (a development process). When the surface of the conductive drum 1 reaches a position (the transfer position) opposite the transfer device 7, the visible image GY on the conductive drum 1 is transferred onto the sheet P at the position opposite the transfer device 7 (a transfer process). Thus, a desired image G is formed onto the sheet P. At this time, a small amount of untransferred conductive liquid Da remains on the conductive drum 1. Most of the untransferred conductive liquid Da naturally volatilizes before reaching the position opposite the applying device 2 again. Thus, a series of image forming processes performed on the surface of the conductive drum 1 is completed. Image forming processes such as the above-described application process and the developing process are described in more detail below with reference to FIGS. 3, 4A, and 4B.

With reference to FIG. 1, a sheet P (transfer target object) conveyed to the transfer position between the conductive drum 1 and the transfer device 7 is conveyed from a sheet feeder 10 installed at a lateral side of the image forming apparatus 100 via a conveyance path K. For example, a feeding roller 11, a conveying roller pair 12, and a registration roller pair 13 are installed on the conveyance path K. Specifically, the sheet feeder 10 contains a stack of multiple sheets P. As the feed roller 11 is rotated clockwise in FIG. 1, the feed roller 11 feeds a top sheet P of the stack of multiple sheets P in the sheet feeder 10 toward the conveyance path K. The sheet P fed to the conveyance path K is conveyed to the conveying roller pair 12 and conveyed to the position of the registration roller pair 13.

The sheet P conveyed to the registration roller pair 13 (timing roller pair) temporarily stops at a position of the roller nip between the registration roller pair 13 that has stopped rotating by a conveying motor. Rotation of the registration roller pair 13 is timed to convey the sheet P toward the transfer position such that the sheet P meets the visible image GY on the conductive drum 1 at the transfer position (or transfer nip). Thus, the desired image G is transferred to the desired position of the sheet P. Thereafter, the sheet P, onto which the image G is transferred at the transfer position, is conveyed to a fixing device 20. In the fixing device 20, the image G transferred on the sheet P is fixed onto the sheet P by application of heat and pressure from a fixing roller 21 and a pressure roller 22 (a fixing process). Thereafter, the sheet P bearing the fixed toner image is conveyed through the conveyance path K and ejected outside the image forming apparatus 100 by an ejection roller pair 14. The sheets P ejected to the outside of the image forming apparatus 100 by the ejection roller pair 14 are sequentially stacked as print media on an ejection tray 15. Thus, a series of image forming processes (printing operation) in the image forming apparatus 100 is completed.

The configuration and operation of the image forming apparatus 100 according to the present embodiment are described in further detail below. As described above with reference to FIGS. 1 and 2, the image forming apparatus 100 according to the present embodiment includes the conductive drum 1 as a conductive medium, the applying device 2, the developing device 3, and the transfer device 7.

The conductive drum 1 as a conductive medium is a rotator that rotates in a specified rotational direction (clockwise in FIG. 2). The conductive drum 1 may be formed of only a conductive layer 1a as illustrated in FIG. 3 or may be formed of a laminated member of the conductive layer 1a and an insulating layer 1b as illustrated in FIGS. 4A and 4B. With reference to FIGS. 3, 4A, and 4B, in either of the cases, the conductive layer 1a is electrically grounded (earthed) and is used to form a channel of electric charge. With reference to FIGS. 4A and 4B, in a case where the conductive drum 1 is provided with the insulating layer 1b, the insulating layer 1b is laminated on the outer surface of the conductive layer 1a with respect to the center of rotation of the conductive drum 1 and is absorptive of the conductive liquid D, and then functions as a permeating layer containing conductive liquid Da. The insulating layer 1b is formed of bristles having an insulating property (capable of holding the conductive liquid D by a capillary phenomenon) densely packed. As the insulating layer 1b, a stack of fibers having an insulating property (e.g., a sheet of paper) can also be used. In the present embodiment, as illustrated in FIGS. 4A and 4B, the conductive drum 1 has a double-layer structure including the conductive layer 1a and the insulating layer 1b. The conductive drum 1 is not limited thereto. In addition, the conductive drum 1 may have a single layer structure as illustrated in FIG. 3 or may have, for example, a structure in which a layer having no conductivity is disposed under the conductive layer 1a.

The conductive drum 1 (conductive medium) in the present embodiment is detachably disposed (as a unitized component) in a body of the image forming apparatus 100 in order to improve maintainability as well as other units (for example, the applying device 2, the developing device 3, the transfer device 7, and the fixing device 20). The conductive layer 1a contacts and separates from a ground portion of the body of the image forming apparatus 100 in conjunction with attachment and detachment of the conductive drum 1 to and from the body of the image forming apparatus 100. The ground portion is disposed in a housing made of conductive material in the body of the image forming apparatus 100.

The applying device 2 applies (supplies) the conductive liquid D onto the surface of the conductive drum 1 (conductive medium) to form an invisible image GN (latent image) according to the difference in conductivity between the conductive liquid D and the surface of the conductive drum 1. Specifically, the applying device 2 is an inkjet device that discharges conductive liquid D (droplets having conductivity) stored therein toward the surface of the conductive drum 1 from a discharge section 2a. A controller 80 controls the applying device 2 to discharge the conductive liquid D from the discharge section 2a (including a discharge range and a discharge concentration) based on image information input to the image forming apparatus 100 by a user via a personal computer, so that the invisible image GN based on the image information is formed on the surface of the conductive drum 1. With such a configuration, the applying device 2 forms the invisible image GN with a conductor (conductive liquid D) having different electrical characteristics on the surface layer (insulating layer 1b) of the conductive drum 1. Since the conductive drum 1 (conductive medium) has conductivity only in the portion on which the conductive liquid D is applied, the invisible image GN is formed with a conductor and an insulator when the conductive drum 1 is viewed from a remote position.

The conductive liquid D in the present embodiment is liquid having conductivity, and high permeability and volatility. The conductive liquid D contains accelerated volatilization auxiliary agent. The conductive liquid D is formed so that the content of visible pigment is 20% or less. With reference to FIG. 2, in the present embodiment, a contact angle θ between the conductive liquid D applied (discharged) by the applying device 2 and the conductive drum 1 is set to be 45 degrees or more (substantially 90 degrees in the present embodiment) in order to properly perform the applying process as described above.

With reference to FIG. 2, the developing device 3 adheres charged particles T to the invisible image GN formed on the surface of the conductive drum 1 (conductive medium) to form a visible image GY. Specifically, the developing device 3 includes the developing roller 3a and a regulating blade 3b. The charged particles T (chargeable particles) are stored in the developing device 3. The developing roller 3a faces the conductive drum 1 (conductive medium) with a clearance H (see FIGS. 3, 4A, and 4B) therebetween. The developing roller 3a is driven by a motor to rotate in a specified direction (counterclockwise in FIG. 2), while a specified voltage is applied from a power supply unit 85 controlled by the controller 80. At this time, since the conductive layer 1a of the conductive drum 1 is grounded (earthed), current and electric field can be generated between the conductive layer 1a and the developing roller 3a connected to the power supply unit 85. The regulating blade 3b is disposed to contact the developing roller 3a on the upstream side in the rotational direction with respect to a position where the developing roller 3a faces the conductive drum 1. The regulating blade 3b is made of, for example, a thin metal plate. The charged particles T borne on the surface of the developing roller 3a are triboelectrically charged at the position of the regulating blade 3b and are sufficiently charged (negatively charged in the present embodiment). The charged particles T passed through the position of the regulating blade 3b are also sufficiently charged by the current (or an electric field formed at the position) flowing between the developing roller 3a and the conductive drum 1. A voltage (development potential) is applied between the conductive layer 1a (conductor) formed as the lower layer of the conductive drum 1 and the developing roller 3a that supplies the charged particles T, so that the charged particles T are adhered to (developed on) the invisible image GN to form the visible image GY. Known toner (dry toner) used in an electrophotographic image forming apparatus can be used as the charged particle T.

A description is given below of the above-described developing process in further detail with reference to FIGS. 3, 4A, and 4B. As described above, when a specified voltage is applied to the developing roller 3a, as illustrated in FIG. 3, current flows through the charged particles T when the conductive liquid D (the invisible image GN) is in the clearance H between the developing roller 3a and the conductive drum 1. At this time, the charged particles T move from the surface of the developing roller 3a to the surface of the conductive drum 1 on which the invisible image GN is formed by action of an electrical force generated at the same time. Thus, the visible image GY (image area) is formed on the surface of the conductive drum 1 by the charged particles T. On the other hand, as illustrated in FIGS. 4A and 4B, in the case of a two-layer structure where a surface layer (insulating layer 1b) is laminated on the conductive layer 1a, the applied conductive liquid D (invisible image GN) penetrates into the surface layer (insulating layer 1b), and conductivity is generated from the conductive layer 1a to the liquid surface of the conductive liquid D on the surface layer via the penetrated conductive liquid Da. Thus, current flows via the charged particles T. At this time, the charged particles T move from the surface of the developing roller 3a to the surface of the conductive drum 1 on which the invisible image GN is formed by action of an electrical force generated at the same time. Thus, the visible image GY (image area) is formed on the surface of the conductive drum 1 by the charged particles T. In other words, the conductive drum 1 and the charged particles T contact (or approach very close to) each other, so that a flow path is formed in which a current flows in response to a voltage applied to the developing roller 3a in the portion of the conductive liquid D (invisible image GN). Then, an electric field formed between the developing roller 3a and the conductive drum 1 also increases. As a result, in the portion applied with the conductive liquid D, the charged particles T on the surface of the developing roller 3a move to the surface of the conductive drum 1, and the charged particles T adhere to the invisible image GN to form the visible image GY. The charged particles T moved onto the conductive drum 1 are held (borne) by an image force between the charged particles T and the conductive drum 1. The conductive liquid D that has been applied to the conductive drum 1 gradually evaporates into the air and disappears after the transfer process. On the other hand, as illustrated in FIG. 4B, when the conductive liquid D (invisible image GN) is not filled in a clearance H between the developing roller 3a and the conductive drum 1, a relatively large clearance R is formed between the conductive drum 1 and the charged particles T borne on the developing roller 3a, so that a flow path through which a current flows in response to a voltage applied to the developing roller 3a is not formed. Then, an electric field formed between the developing roller 3a and the conductive drum 1 also decreases. As a result, this portion is a non-image area in which the charged particles T do not move and the visible image G is not formed.

With reference to FIG. 2, the transfer device 7 is disposed to contact (or face) the conductive drum 1 at the transfer position downstream from the developing device 3 in the rotational direction of the conductive drum 1 (conductive medium). The transfer device 7 transfers the visible image GY formed on the surface of the conductive drum 1 to the sheet P serving as a transfer target object conveyed to the transfer position. A voltage (a voltage of a positive polarity in the present embodiment) for transferring the visible image GY on the conductive drum 1 onto the sheet P is applied to the transfer device 7 from the power supply unit 85. In the present embodiment, a transfer roller that contacts the conductive drum 1 to form the transfer position (transfer nip) is used as the transfer device 7. The transfer device 7 is not limited thereto, and for example, a transfer device that faces the conductive drum 1 with a gap therebetween can also be used.

As described above, unlike an electrophotographic image forming apparatus, the image forming apparatus 100 according to the present embodiment does not use, for example, a charging device that generates an electrical discharge phenomenon by application of a voltage of several hundred volts, or an exposure device that includes a large number of optical elements and is controlled in a complicated manner. Accordingly, the image forming apparatus 100 according to the present embodiment is lower in cost and smaller in size compared to the electrophotographic image forming apparatus. Unlike the electrophotographic image forming apparatus, the image forming apparatus 100 according to the present embodiment does not generate ozone by a charging device, and does not require time and labor to periodically replace an ozone filter for removing ozone.

### First Modification

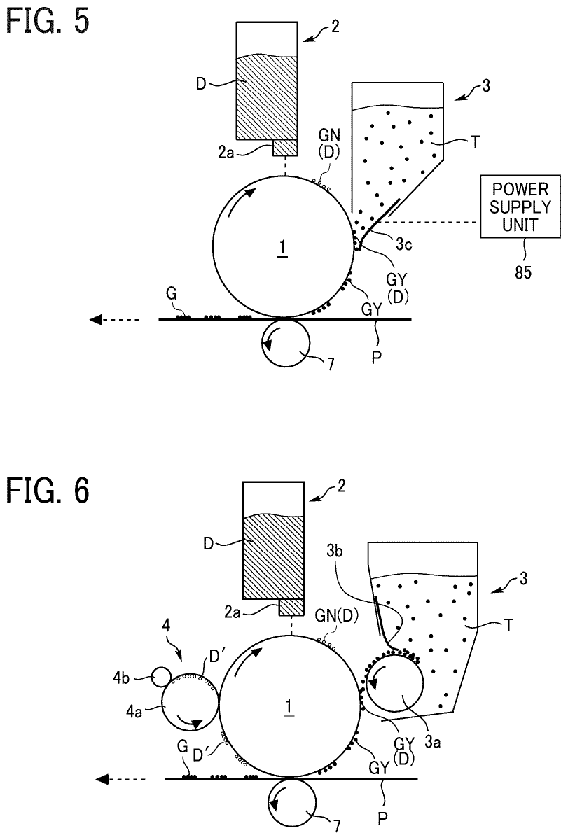

As illustrated in FIG. 5, in an image forming apparatus 100 according to a first modification of the above-described embodiments of the present disclosure, the developing device 3 is provided with, instead of the developing roller 3a and the regulating blade 3b, a developing blade 3c that contacts the conductive drum 1 (conductive medium) with a specified contact pressure and angle while a specified voltage is applied from the power supply unit 85. Specifically, the developing blade 3c is a substantially rectangular metal plate and contacts the conductive drum 1 to lie flat along the rotational direction of the conductive drum 1. The developing blade 3c is connected to the power supply unit 85 and is applied with a specified high-frequency voltage (developing potential). Also in the case of such a configuration, the charged particles T stored in the developing device 3 are sufficiently charged by friction at a contact position between the developing blade 3c and the conductive drum 1, and an electric field formed at the contact position. Thus, the charged particles T adhere to the invisible image GY on the conductive drum 1 to form the visible image GY. At this time, the applied high-frequency voltage acts as an auxiliary electric field for uniformly aligning the charged particles T on the surface layer of the conductive drum 1. Even in the case of such a configuration, a charging device and an exposure device are obviated.

### Second Modification

As illustrated in FIG. 6, an image forming apparatus 100 according to a second modification of the above-described embodiments of the present disclosure further includes a drying device 4 that dries the surface of the conductive drum 1 as a conductive medium. The drying device 4 is disposed to contact (or face) the conductive drum 1 at a position downstream from the transfer device 7 in the rotation direction of the conductive drum 1 (conductive medium) and upstream from the applying device 2 in the rotation direction of the conductive drum 1. More specifically, the drying device 4 includes a pressing roller 4a as an absorber and a heater 4b as a volatilization accelerator. The pressing roller 4a as an absorber contacts the conductive drum 1 (conductive medium) to absorb the conductive liquid Da adhering to the surface of the conductive drum 1. The conductive liquid Da is conductive liquid (including charged particles T) remaining on the drum surface after the transfer process. The heater 4b as a volatilization accelerator volatilizes (evaporates) the conductive liquid Da absorbed by the pressing roller 4a (absorber) by heat. Even in a case where the conductive liquid Da remaining on the conductive drum 1 after the transfer process does not sufficiently and naturally volatilize by the time the conductive liquid Da reaches the position facing the applying device 2 (e.g., a case where the conductive drum 1 is rotated at a high speed and a time for naturally volatilizing the conductive liquid Da cannot be sufficiently ensured), the drying device 4 disposed as described above can forcibly volatilize (remove) the remaining conductive liquid Da. Accordingly, inconvenience that an afterimage is formed on the image G by the conductive liquid Da remaining on the conductive drum 1 is prevented. In the present embodiment, the heater 4b as a volatilization accelerator volatilizes (evaporates) the conductive liquid Da absorbed by the pressing roller 4a (absorber) with the heat of the heater 4b. The volatilization accelerator is not limited to the heater 4b, and for example, a member that supplies energy, such as UV light, may be used as the volatilization accelerator so that the conductive liquid Da absorbed by the pressing roller 4a (absorber) is volatilized (evaporated) by the energy.

### Third Modification

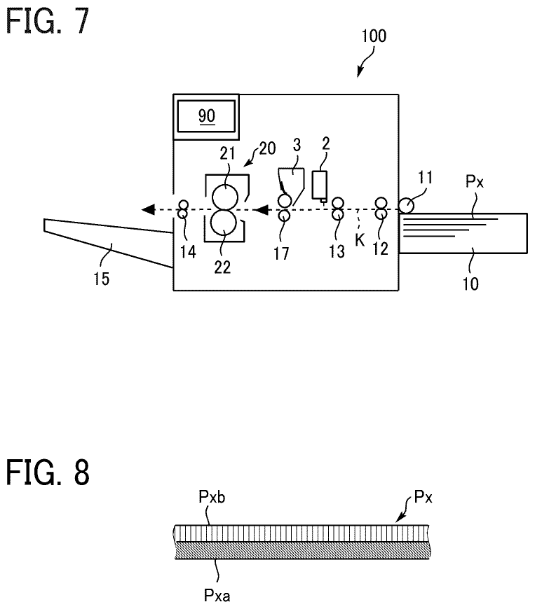

As illustrated in FIG. 7, an image forming apparatus 100 according to a third modification of the above-described embodiments of the present disclosure uses a print medium Px as a conductive medium. Specifically, in the image forming apparatus 100 according to the third modification, the conductive drum 1 is not disposed unlike the image forming apparatus 100 illustrated in FIG. 1. A sheet feeder 10, a feeding roller 11, a conveying roller pair 12, a registration roller pair 13, an applying device 2, a developing device 3 (and a pressing roller 17), a fixing device 20, an ejection roller pair 14, and an ejection tray 15 are arranged in this order from the upstream side in a conveyance path K along which the print medium Px is conveyed. As illustrated in FIG. 8, the print medium Px as a conductive medium includes a conductive layer Pxa, and an insulating layer Pxb that is laminated on the printing surface side relative to the conductive layer Pxa and can absorb the conductive liquid D. The print medium Px is fed from the sheet feeder 10 and conveyed to pass a position opposite the applying device 2 and then pass a position opposite the developing device 3. An applying process is performed at the position of the applying device 2 by a similar, even if not the same, mechanism with that described above with reference to FIG. 1. A developing process is performed at the position of the developing device 3 by a similar, even if not the same, mechanism with that described above with reference to FIG. 1. In other words, after the conductive liquid D is applied to the printing surface (upper surface) of the print medium Px by the applying device 2 to form the invisible image GN, the charged particles T are adhered to the invisible image GN formed on the printing surface of the print medium Px by the developing device 3 to form the visible image GY. The developing roller 3a of the developing device 3 is disposed to form a developing nip between the developing roller 3a and the pressing roller 17. The charged particles T are supplied by the developing roller 3a to the invisible image GN on the print medium Px conveyed toward the developing nip, and the visible image GY (image G) is formed on the print medium Px. The visible image GY (image G) on the print medium Px is fixed on the print medium Px at the position of the fixing device 20, and the print medium Px is ejected onto the ejection tray 15. A voltage that causes the charged particles T on the developing roller 3a to move toward the developing roller 3a (a voltage having a positive polarity in the third modification) is applied to the pressing roller 17 until the print medium Px is conveyed to the developing nip. A zero potential or a voltage that causes the charged particles T to move toward the pressing roller 17 (a voltage having a negative polarity in the third modification) is applied when the print medium Px is placed in the developing nip. Thus, an inconvenience that the pressing roller 17 is contaminated by the charged particles T is prevented. With such a mechanism, the pressing roller 17 can be grounded to form an electric field between the pressing roller 17 and the developing roller 3a, and can also actively apply a voltage having positive polarity. In the image forming apparatus 100 configured as described above, a charging device and an exposure device are obviated.

As described above, the image forming apparatus 100 according to any one of the above-described embodiments and modifications includes the applying device 2 that forms the invisible image GN by applying the conductive liquid D on the surface of the conductive drum 1 (conductive medium) and the developing device 3 that forms the visible image GY by causing the charged particles T to adhere to the invisible image GN formed on the surface of the conductive drum 1. As a result, a charging device and an exposure device are obviated.

In any one of the above-described embodiments and modifications, the conductive drum 1 (conductive medium), the applying device 2, and the developing device 3 may be integrally unitized as an image forming unit and may be installed removably (replaceably) in the body of the image forming apparatus 100. Even in such a configuration, effects equivalent to those of the above-described embodiments and modifications can be achieved.

Note that embodiments of the present disclosure are not limited to the above-described embodiments, and it is apparent that the above-described embodiments can be appropriately modified within the scope of the technical idea of the present disclosure in addition to what is suggested in the above-described embodiments. The number, position, and shape of the components described above are not limited to those embodiments described above. Desirable number, position, and shape can be determined to perform the present disclosure.

### First Aspect

An image forming apparatus (e.g., the image forming apparatus 100) includes a conductive medium (e.g., the conductive drum 1), an applying device (e.g., the applying device 2), and a developing device (e.g., the developing device 3). The applying device applies conductive liquid (e.g., the conductive liquid D) to a surface of the conductive medium to form an invisible image (e.g., the invisible image GN). The developing device adheres charged particles (e.g., the charged particles T) to the invisible image formed on the surface of the conductive medium to form a visible image (e.g., the visible image GY).

### Second Aspect

In the image forming apparatus (e.g., the image forming apparatus 100) according to the first aspect, the conductive medium (e.g., the conductive drum 1) includes a conductive layer (e.g., the conductive layer 1a) and an insulating layer (e.g., the insulating layer 1b). The insulating layer is laminated on an outer surface of the conductive layer and is absorptive of the conductive liquid (e.g., the conductive liquid D).

### Third Aspect

In the image forming apparatus (e.g., the image forming apparatus 100) according to the second aspect, the conductive layer (e.g., the conductive layer 1a) is electrically grounded, and the insulating layer (e.g., the insulating layer 1b) includes densely packed bristles having an insulating property or a stack of fibers having an insulating property.

### Fourth Aspect

The image forming apparatus (e.g., the image forming apparatus 100) according to any one of the first to third aspects further includes a transfer device (e.g., the transfer device 7) and a drying device (e.g., the drying device 4). The conductive medium (e.g., the conductive drum 1) is a rotator that rotates in a specified rotational direction. The transfer device is disposed to face or contact the conductive medium at a transfer position downstream from the developing device (e.g., the developing device 3) in the rotational direction, and transfers the visible image (e.g., the visible image GY) formed on the surface of the conductive medium to a transfer target object (e.g., the sheet P) conveyed to the transfer position. The drying device is disposed to face or contact the conductive medium downstream from the transfer device in the rotational direction and upstream from the applying device (e.g., the applying device 2) in the rotational direction, and dries the surface of the conductive medium.

### Fifth Aspect

In the image forming apparatus (e.g., the image forming apparatus 100) according to the fourth aspect, the drying device (e.g., the drying device 4) includes an absorber (e.g., the pressing roller 4a) and a volatilization accelerator (e.g., the heater 4b). The absorber contacts the conductive medium (e.g., the conductive drum 1) to absorb the conductive liquid (e.g., the conductive liquid Da) adhering to the surface of the conductive medium. The volatilization accelerator volatilizes the conductive liquid absorbed by the absorber.

### Sixth Aspect

In the image forming apparatus (e.g., the image forming apparatus 100) according to the fourth or fifth aspect, the conductive medium (e.g., the conductive drum 1) is detachably attached to a body of the image forming apparatus.

### Seventh Aspect

In the image forming apparatus (e.g., the image forming apparatus 100) according to any one of the first to sixth aspects, the developing device (e.g., the developing device 3) includes a developing roller (e.g., the developing roller 3a) that faces the conductive medium (e.g., the conductive drum 1) with a gap and rotates in a specified direction while being applied with a specified voltage.

### Eighth Aspect

In the image forming apparatus (e.g., the image forming apparatus 100) according to any one of the first to sixth aspects, the developing device (e.g., the developing device 3) includes a developing blade (e.g., the developing blade 3c) that contacts the conductive medium (e.g., the conductive drum 1) while being applied with a specified voltage.

### Ninth Aspect

In the image forming apparatus (e.g., the image forming apparatus 100) according to any one of the first, second, third, seventh, and eighth aspects, the conductive medium (e.g., the conductive drum 1) is a print medium (e.g., the print medium Px) that is conveyed to pass a position opposite the applying device (e.g., the applying device 2) and then pass a position opposite the developing device (e.g., the developing device 3).

### Tenth Aspect

A print medium (e.g., the print medium Px) includes a conductive layer (e.g., the conductive layer Pxa) and an insulating layer (e.g., the insulating layer Pxb). The insulating layer is laminated on a printing surface side relative to the conductive layer and is absorptive of conductive liquid (e.g., the conductive liquid D).

### Eleventh Aspect

In the print medium (e.g., the print medium Px) according to the tenth aspect, after the conductive liquid (e.g., the conductive liquid D) is applied to a printing surface of the print medium by an applying device (e.g., the applying device 2) to form an invisible image (e.g., the invisible image GN), charged particles (e.g., the charged particles T) are adhered to the invisible image formed on the printing surface of the print medium by a developing device (e.g., the developing device 3) to form a visible image (e.g., the visible image GY).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An image forming apparatus comprising:
a conductive medium;
an applying device to apply conductive liquid to a surface of the conductive medium to form an invisible image; and
a developing device to adhere charged particles to the invisible image formed on the surface of the conductive medium to form a visible image.

2. The image forming apparatus according to claim 1,
wherein the conductive medium includes a conductive layer and an insulating layer laminated on an outer surface of the conductive layer, and the conductive medium is absorptive of the conductive liquid.

3. The image forming apparatus according to claim 2,
wherein the conductive layer is electrically grounded, and
wherein the insulating layer includes densely packed bristles having an insulating property or a stack of fibers having an insulating property.

4. The image forming apparatus according to claim 1,
wherein the conductive medium is a rotator to rotate in a specified rotational direction, and
wherein the image forming apparatus further comprises:
a transfer device disposed to face or contact the conductive medium at a transfer position downstream from the developing device in the rotational direction, the transfer device to transfer the visible image formed on the surface of the conductive medium to a transfer target object conveyed to the transfer position, and
a drying device disposed to face or contact the conductive medium downstream from the transfer device in the rotational direction and upstream from the applying device in the rotational direction, the drying device to dry the surface of the conductive medium.

5. The image forming apparatus according to claim 4, wherein the drying device includes:
an absorber that contacts the conductive medium to absorb the conductive liquid adhering to the surface of the conductive medium; and
a volatilization accelerator that volatilizes the conductive liquid absorbed by the absorber.

6. The image forming apparatus according to claim 4,
wherein the conductive medium is detachably attached to a body of the image forming apparatus.

7. The image forming apparatus according to claim 1,
wherein the developing device includes a developing roller that faces the conductive medium with a gap and rotates in a specified direction while being applied with a specified voltage.

8. The image forming apparatus according to claim 1,
wherein the developing device includes a developing blade that contacts the conductive medium while being applied with a specified voltage.

9. The image forming apparatus according to claim 1,
wherein the conductive medium is a print medium that is conveyed to pass a position opposite the applying device and then pass a position opposite the developing device.

10. A print medium comprising:
a conductive layer; and
an insulating layer laminated on a printing surface side relative to the conductive layer, the insulating layer being absorptive of conductive liquid.

11. The print medium according to claim 10,
wherein after the conductive liquid is applied to a printing surface of the print medium by an applying device to form an invisible image, charged particles are adhered to the invisible image formed on the printing surface of the print medium by a developing device to form a visible image.
